(19) United States
(12) Patent Application Publication
(10) Pub. No.: US 2005/0151620 A1
(43) Pub. Date: Jul. 14, 2005

(54) Household appliance with a biometric person-identifying device

(75) Inventor: Michael Neumann, Ulm (DE)

Correspondence Address: JOHN T. WINBURN, 100 BOSCH BOULEVARD, NEW BERN, NC, 28562, US

(73) Assignee: BSH Bosch und Siemens Hausgerate, GmbH, Munich (DE)

(21) Appl. No.: 11/040,062

(22) Filed: Jan. 21, 2005

(30) Foreign Application Priority Data
Aug. 13, 2002 (DE) 10237132.6
Jul. 24, 2003 (WO) PCT/EP03/08159

(51) Int. Cl. G06K 9/00

(52) U.S. Cl. 340/5.52; 340/5.73; 382/100

(57) ABSTRACT

A household appliance, such as a refrigerator or freezer, having a door and a locking device on the door. The locking device is controlled by a biometric person-identifying device. The biometric identification can be based on recognition of at least one of the person's fingerprint, voice characteristics or iris pattern.

The present invention relates to household appliances which have an appliance door and a locking device for the appliance door. The present invention especially relates to refrigerators or freezers.

Simple locking mechanisms are known for refrigerators. These are for example bolts which are integrated on the handle of the appliance door so that on closing the appliance door by means of the handle, the bolt automatically engages in a corresponding recess on the refrigerator casing. These simple locking mechanisms however bring with them the disadvantage that they can be operated by anyone. This means that any person can gain access to the refrigerator.

Especially in the case of freezers, known locking mechanisms with locks and corresponding keys certainly ensure that only authorised persons can gain access. However, these locking mechanisms are expensive and not very user-friendly since the user must always have a key available in order to be able to open the appliance door.

It is thus the object of the present invention to provide a household appliance with an appliance door and a locking device for the appliance door which can be operated in a user-friendly fashion.

The object is solved by a household appliance according to claim 1. According to this, a household appliance with an appliance door and a locking device for the appliance door is provided wherein the household appliance has a biometric person-identifying device to control the locking device. The person-identifying device usually controls the locking device to unlock the appliance door. This means that unlocking of the appliance door by the locking device only takes place by previous identification of the user as an authorised appliance user by the person-identifying device.

The term biometric within the framework of the present invention means that the person identification is based on the recognition of a physical feature characteristic only of the appliance user. This can, for example, be a finger print, speech or the iris of a person. For this purpose the biometric person-identifying device has corresponding devices to record or take the biometric features. These can be a finger print recording device, a speech recording device or an iris recording device. The person-identifying device can have one or a plurality of these devices. These devices for recording a biometric feature are preferably arranged on the household appliance at a level at which the biometric feature can be taken in the most user-friendly manner. If the iris is to be recorded for example, then the iris recording device is preferably arranged at the level of the eyes of the user standing in front of the appliance.

The present invention has the advantage that the appliance door can only be unlocked and opened by one person who is identified as access-authorised by the biometric person-identifying device. Not any person can unlock and open the door of the household appliance. The advantage of the present invention is especially that this is a user-friendly system. The user always has his person-specific physical or biometric feature with him which is checked by the person-identifying device of the household appliance. There is no need to carry a key to unlock the door as in the case of a household appliance locked with a lock.

The household appliance can be a refrigerator or a freezer. However, the present invention can also be used for other household appliances with an appliance door, for example in washing machines, tumble driers, spin-driers and dishwashers. The present invention can also be used for household appliances which are used industrially such as washing machines in launderettes.

As has already been explained previously, the person-identifying device usually controls the locking device to unlock the appliance door. However, the person-identifying device can also control the locking device to lock the appliance door. This means that first the operating person is identified by the biometric person-identifying device. If the operating person is established as access-authorised, the person-identifying device controls the locking device to lock the appliance door. The locking device is preferably configured however such that the appliance door is automatically locked on closing. Accordingly, locking takes place without previous identification of the person. This is user-friendly.

For safety reasons the household appliance can have a safety device for unlocking the appliance door wherein the safety device for its part has a sensor for registering movements inside the household appliance. The safety device is preferably configured such that when necessary, it controls the locking device already present in the household appliance to unlock the appliance door. The safety device is then used if a child or pet is inside the locked household appliance by mistake. The sensor records movements of the person or the animal. The safety device thereupon immediately unlocks the door. The child can then open this. The door is preferably not only unlocked but also opened with the aid of the safety device. This then comes in useful if the person who has been locked in is no longer capable of opening the door themselves because of panic or in general if a locked-in animal is involved. The movement sensor can be an infrared movement sensor for example. Within the scope of the present invention, the movement sensor is preferably a strain gauge which is arranged to register any deformation of the household appliance inner wall. This is because it is usually assumed that a person who is locked in will knock on the inner wall of the appliance in order to make themselves noticed or to attempt to open the appliance door from inside. By this means the inner wall of the appliance is temporarily deformed which is registered by the strain gauge. The strain gauge is preferably located on the inner wall of the appliance door. Advantageously, a plurality of strain gauges can also be used. These can extend either vertically and/or horizontally over the total length of the inner wall of the appliance door or cross-wise and inclined.

Within the scope of the present invention the locking device is preferably configured such that the appliance door stays locked in the voltageless state. It is hereby ensured that any unauthorised person cannot gain access to the household appliance by simply removing the mains plug. The appliance door stays locked.

The household appliance preferably has a buffer current supply device. The buffer current supply can be provided, for example with the aid of a rechargeable battery. The buffer current supply device ensures that the household appliance is supplied with current despite a mains power failure for example. The buffer current supply device preferably supplies the locking device and the person-identifying device. It is thereby achieved that any unlocking or locking of the household appliance door is still possible even in the event of a power failure. An especially preferred embodiment of the present invention provides that the buffer current supply device supplies the safety device. This ensures that the doors are always unlocked if a person or an animal is located by mistake in the locked household appliance.

Further embodiments and advantages of the present invention are explained subsequently with reference to an embodiment of the present invention. In the figures:

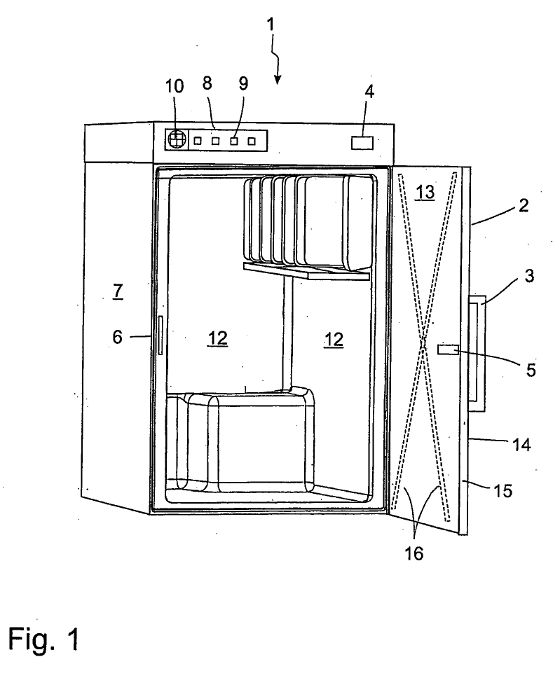

FIG. 1 is a perspective view of a refrigerator 1 according to the present invention

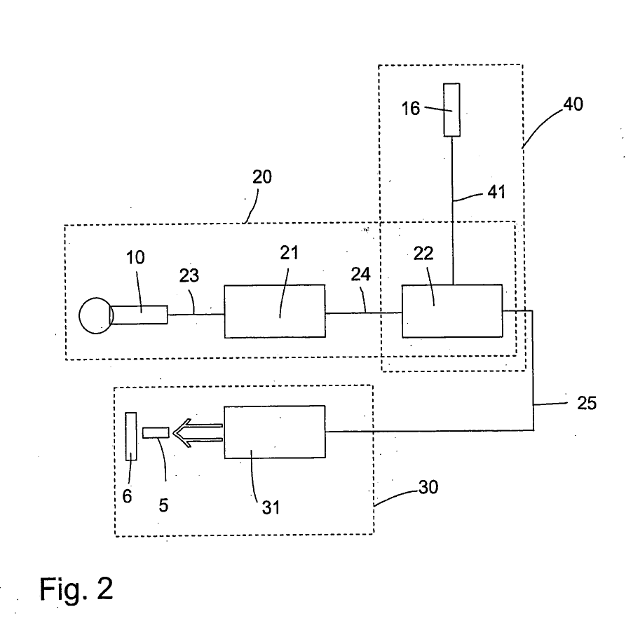

FIG. 2 is a block diagram comprising devices of the refrigerator 1 according to FIG. 1.

FIG. 1 shows a refrigerator 1 with an appliance door 2 which is open in the state shown. The appliance door 2 comprises a door handle 3. A temperature display 4 on the refrigerator 1 gives the actual temperature in the interior of the refrigerator. The refrigerator 1 furthermore has a bolt 5 on the appliance door 2 and a bolt engagement 6 on the casing 7 of the refrigerator 1. Arranged on the front of the refrigerator 1 above the appliance door 2 is a control panel 8 with buttons 9. Located to the left next to the control panel 8 is a microphone 10. The household appliance 1 comprises inner walls 12 which define an interior space 11. Located among these is also an appliance door inner wall 13 of the appliance door 2. The appliance door 2 further comprises an appliance outer wall 14. Located between the appliance door inner wall 13 and the appliance door outer wall 14 is an interior space 15. In this interior space 15 two strain gauges 16 are arranged offset cross-wise on the appliance door inner wall 13. The strain gauges 16 are shown by dashed lines.

FIG. 2 shows a block diagram comprising devices of the refrigerator 1. This is substantially a black box diagram by means of which the further devices of the refrigerator 1 and its mode of operation are explained. The refrigerator 1 accordingly further comprises a biometric person-identifying device 20 with the microphone 10 already shown in FIG. 1 as a speech recording device, an analogue/digital converter 21 and a microprocessor 22 which are connected to one another via leads 23 and 24. Furthermore, the refrigerator 1 has a locking device 30 with a control element 31, for example, a coil 31 and the bolt 5 and bolt engagement 6 already shown in FIG. 1. The microprocessor 22 of the person-identifying device 20 is connected to the control element 31 of the locking device 30 via a lead 25. The refrigerator 1 also has a safety device 40 which comprises the microprocessor 22 of the person-identifying device 20 and the strain gauges 16 already shown in FIG. 1, which are connected to one another via the lead 41.

The mode of operation of the present invention is explained in detail subsequently with reference to FIGS. 1 and 2.

In FIG. 1 the appliance door 2 of the refrigerator 1 is open and unlocked. If the appliance user closes the appliance door 2 of the refrigerator 1 by means of the door handle 3, the appliance door is automatically locked by the locking device 30 by the bolt 5 engaging in the bolt engagement 6. It is no longer easily possible for the user to open the appliance door 2 by means of the door handle 3.

Should the appliance user wish to open the appliance, door 2, this must first be unlocked. The appliance door 2 is unlocked by means of the biometric person-identifying device 20 and the locking device 30 which is explained in detail subsequently. The microphone 10 records the speech of the user. The resulting analogue signals are fed via the lead 23 to the analogue/digital converter 21 which converts the analogue speech signals into digital speech signals. These are then supplied via the lead 24 to the microprocessor 22 in which the speech signals are compared with speech signals of authorised persons already stored there. If specified parameters of the actually recorded speech signals agree with those of the stored speech signals, the microprocessor via the lead 25 controls the coil 31 of the locking device 30, which then moves the bolt 5 so that this is no longer engaged in the bolt engagement 6 and thus the appliance door 2 is unlocked. The appliance door 2 can then be opened by the user recognised as authorised. If the actually recorded speech signals do not agree with the stored speech signals, the microprocessor 22 then does not control the locking device 30. The appliance door 2 remains locked. The person not recognised as authorised cannot open the appliance door 2. The previous storage of the speech signals of the authorised persons in the microprocessor 22 is likewise carried out via the microphone 10 and the analogue/digital converter 21. In order that this storage of authorising speech signals cannot be undertaken by any person, a numerical code specified by the appliance manufacturer for example must be entered via the control panel 8 by means of the buttons 9.

Instead of the microphone 10, the refrigerator can also have a camera 10 for recording the iris or the fingerprint of the user as alternative biometric features. Alternatively to the automatic locking of the appliance door 2 during closure it can also be provided that the appliance door 2 can only be locked by previous identification of the person by means of the person-identifying device 20. In this case, after an authorisation had been established, the microprocessor 22 would then control the locking device 30 to lock the appliance door 2. If an unauthorised user closes the door 2, or if the authorised user closes the door without having their authorisation checked, the door stays unlocked. This is appropriate if the authorised user wishes to allow others access to the refrigerator 1 or if the wishes to access the refrigerator several times in quick succession and in this case does not wish to have his authorisation checked every time.

The safety device 40 is used to unlock the appliance door 2 in an emergency. Such an emergency is given if a person or an animal is locked in the household appliance by mistake. The appliance door 2 is closed and locked and thus can no longer be opened from inside the household appliance 1. If a person locked in by mistake knocks on the appliance door inner wall 13, one of the two or both strain gauges 16 are stretched. The signals from the strain gauges 16 are passed on to the microprocessor 22 via the lead 41. The microprocessor 22 then controls the locking device 30 or the coil 31 which moves the bolt 5 from the bolt engagement 6 whereby the appliance door 2 is unlocked. The appliance door can then be opened from inside the household appliance 1 by the person who is locked in.

An emergency power supply (not shown in FIG. 2) e.g. in the form of a small rechargeable battery which is charged during normal mains operation of the refrigerator can be provided in order to at least keep the person-identifying device 20 and the safety device 40 operating for a time in the event of a failure of the mains voltage. Thus, in the event of a power failure, the authorised user can still unlock the appliance door 2 and access refrigerated goods stored in the refrigerator. It is also important for the safety device 40 that this continues to function in the event of a power failure.

1-14. (canceled)

15. A household appliance, comprising:
at least one interior space closed by an appliance door;
a locking device for said appliance door for locking said interior space with said appliance door; and
a biometric person-identifying device for controlling said locking device.

16. The household appliance according to claim 15, including said biometric person-identifying device for controlling said locking device to unlock said appliance door.

17. The household appliance according to claim 15, including said locking device is configured to lock said appliance door automatically upon closing said interior space by said appliance door.

18. The household appliance according to claim 15, including said biometric person-identifying device for controlling said locking device to lock said appliance door.

19. The household appliance according to claim 15, including said biometric person-identifying device is operated by a fingerprint recording device.

20. The household appliance according to claim 15, including said biometric person-identifying device is operated by a speech recording device.

21. The household appliance according to claim 15, including said biometric person-identifying device is operated by an iris recording device.

22. The household appliance according to claim 15, further including a safety device for unlocking said applicance door and said safety device includes a sensor for recording movements in said interior space.

23. The household appliance according to claim 22, including said sensor is constructed as a pressure sensor for recording any deformation of an interior wall of said interior space.

24. The household appliance according to claim 22, including said sensor is constructed as a strain gauge for recording any deformation of an interior wall of said interior space.

25. The household appliance according to claim 15, including said locking device is configured such that said appliance door remains locked in a powerless state.

26. The household appliance according to claim 15, further including a buffer current supply device to power at least said biometric person-identifying device during a power failure.

27. The household appliance according to claim 26, further including a safety device for unlocking said appliance door and said buffer current supply device powers said biometric person-identifying device and said safety device during a power failure.

28. The household appliance according to claim 22, including said buffer current supply device powers said safety device during a power failure.

29. The household appliance according to claim 15, including said household appliance is one of a refrigerator and a freezer.

30. A method for locking an interior space of a household appliance having an appliance door, comprising:
closing the interior space with the appliance door;
locking said interior space with said appliance door; and
providing a biometric person-identifying device for controlling said locking device.

31. The method according to claim 30, including providing a safety device for unlocking said appliance door and providing said safety device with a sensor for recording movements in said interior space and unlocking said appliance door when movements in said interior space are sensed.

32. The method according to claim 31, including providing a backup power device and supplying power to said biometric person-identifying device and said safety device during a power failure.

33. A household appliance, comprising:
at least one interior space closed by an appliance door;
a locking device for said appliance door for locking said interior space with said appliance door;
a biometric person-identifying device for controlling the locking and unlocking of said locking device; and
said biometric person-identifying device is operated by at least one of a fingerprint recording device, a speech recording device and an iris recording device.

34. The household appliance according to claim 33, further including a safety device for unlocking said appliance door and said safety device includes a sensor for recording movements in said interior space and said sensor is constructed as a pressure sensor for recording any deformation of an interior wall of said interior space.
